(19) United States
(12) Patent Application Publication
(10) Pub. No.: US 2019/0043161 A1
(43) Pub. Date: Feb. 7, 2019

(54) METHOD FOR DEVICE AND USER CONTROL OF TOPOLOGICAL DATA ANALYSIS BY MEANS OF TOPOLOGY EMBEDDING

(71) Applicant: MARTIN BROOKS, CHELSEA (CA)

(72) Inventor: MARTIN BROOKS, CHELSEA (CA)

(21) Appl. No.: 15/668,028

(22) Filed: Aug. 3, 2017

(51) Int. Cl. G06T 3/00; G06F 17/30

(52) U.S. Cl. CPC G06T 3/0031; G06F 17/30958

(57) ABSTRACT

A method of transforming image data comprises receiving, by a Reeb graph stage, from intermediate storage coupled to a sensor, spatial data. Transforming the spatial data to produce a Reeb graph, where the Reeb graph representing the spatial data. Receiving a set of control inputs through an off board interface. Augmenting, the Reeb graph to produce an augmented Reeb graph. The augmented Reeb graph comprising a plurality of new edges, each of the plurality of new edges comprising a first vertex labeled with a scalar value. The scalar value is unequal to any other scalar values associated with a second vertex at the opposing end of the new edge. The set of control inputs determines the plurality of new edges. Transforming the augmented Reeb graph to produce shape data, the shape data comprising a plurality of shapes, and Outputting, by the shape-generation stage, the shape data.

### FIELD OF THE INVENTION

The present invention relates to 2-, 3- and 4-dimensional image processing and more particularly to the transformation of bitmapped images into to vector graphic and geometric image files formats that may be utilized in a number of ways.

### BACKGROUND OF THE INVENTION

There exists a multitude of applications where 2-, 3- and 4-dimensional images are processed to extract information to enable a computer or hardware circuit to make a decision on the contents of the image or images. Examples of these applications include remote sensing, facial recognition, security monitoring, medical imaging, automated driving, and other.

Bitmapped images, where each pixel has an x-y, x-y-z, or x-y-z-t coordinate and a color value, may be difficult to analyze since it is a flat image that lacks shape information and perspective. Bitmapped images may be processed to extract additional information such as boundaries of objects, height information, and facial features but this requires processing power and time that may not meet the requirements for some applications. Furthermore, the amount of information that must be processed increases with the size and resolution of the image making real-time processing of images difficult.

As is known in the art, 2-, 3- and 4-dimensional images may be processed and transformed into vector graphics and geometric file formats which provide resolution independent images and metadata based on collections of shapes. Vector graphic and geometric files allow the image to be scaled and the incorporated shapes may be chosen or organized to give meaning to the contents of the image. Shapes defined by the vector graphic and geometric file formats can represent specific objects, heights, topologies and other features in a way that is resolution independent and can be easily stored and processed by processing systems. In some applications, the vector graphic and geometric shapes can form a hierarchical topology of arbitrary shapes.

A Reeb graph is a mathematical object reflecting the level sets of a real-valued function on a manifold. Reeb graphs have a wide variety of applications in computational geometry and computer graphics, including computer aided geometric design, topology-based shape matching, topological data analysis, and topological simplification. A Reeb graph is comprised of a multitude of vertices, and edges, with a scalar value, labeling each vertex. The Reeb graph is well known to persons skilled in the art. Herein the term “Reeb graph” is used in the broadest sense, denoting any graph structure that expresses the connectivity of level sets, sublevel sets, or superlevel sets of a scalar field defined on a spatial domain having boundaries. Each vertex of a Reeb graph is classified as one of maximum, minimum, or saddle. Each edge of a Reeb graph is like the open interval of the number line, lying between the scalar value labels of the edge's two vertices; in this way every edge point is considered to be labeled with a scalar value.

As known in the art, it is possible to transform a bitmapped 2-, 3-, and 4-dimensional image into a Reeb graph through a variety of means. Furthermore, it is known in the art that the resulting Reeb graph may be transformed into a collection of shapes that may be stored in a vector graphics format for storage and processing.

The data transformation will yield different results depending on the shapes chosen, boundary conditions, completion of incomplete shapes, and other parameters. Different transformations yield different results that will be optimal for one application but not for another. Difficulties in processing bitmapped 2-, 3-, or 4-dimensional image data into vector graphic and geometric formats that may be used for applications prevent the use of this technology for applications where the optimal transformation is not known or in real time applications. Improved methods and apparatus to transform and analyze data are required that meet real time speed requirements and allow a host device or user to perform a number of different transformations easily and quickly are required.

### BRIEF SUMMARY OF THE INVENTION

Embodiments of the invention comprise a method of transforming spatial data comprising receiving, by a Reeb graph stage, from intermediate storage coupled to a sensor, spatial data. Transforming, by the Reeb graph stage, the spatial data to produce a Reeb graph, the Reeb graph representing the spatial data. Receiving a set of control inputs through an off board interface. Augmenting, by an augmented Reeb graph stage, the Reeb graph to produce an augmented Reeb graph. The augmented Reeb graph comprises a plurality of new edges, each of the plurality of new edges comprising a first vertex labeled with a scalar value. The scalar value is unequal to any other scalar values associated with a second vertex at the opposing end of the new edge. The set of control inputs determines the plurality of new edges. Transforming, by a shape-generation stage, the augmented Reeb graph to produce shape data, the shape data comprising a plurality of shapes, and outputting, by the shape-generation stage, the shape data.

Further embodiments of the invention comprise receiving a second set of control inputs through the off board interface and augmenting, by the augmented Reeb graph stage, the Reeb graph to produce a second augmented Reeb graph. The second augmented Reeb graph comprises a second plurality of new edges. Each of the second plurality of new edges comprises a third vertex labeled with a second scalar value, the second scalar value being unequal to any other scalar values associated with a fourth vertex at the opposing end of the new edge. The second set of control inputs determine the second plurality of new edges. Transforming, by the shape-generation stage, the second augmented Reeb graph to product a second shape data, the second shape data comprising a second plurality of shapes. Outputting, by the shape-generation stage, the second shape data, and selecting one of the shape data or the second shape data.

In other embodiments the spatial data comprises a plurality of spatial coordinates and a scalar value.

In other embodiments the method further comprises displaying one of the shape data or the second shape data on a display.

In other embodiments the method further comprises providing one of the shape data or the second shape data to another process.

In other embodiments the selecting is based a first depth of a first hierarchy of the plurality of shapes and a second depth of a second hierarchy of the second plurality of shapes.

In other embodiments the selecting is based a first area of the plurality of shapes and a second area of the second plurality of shapes.

In other embodiments the selecting is based a first perimeter of the plurality of shapes and a second perimeter of the second plurality of shapes.

In other embodiments the first vertex is a boundary vertex.

In other embodiments the scalar value lies outside the range of the any other scalar values.

In other embodiments the scalar value is less than the minimum value of a plurality of scalar values used in the Reeb graph, the new edge being connected to a maximum vertex that is a boundary vertex.

In other embodiments the scalar value is greater than the maximum value of a plurality of scalar values used in the Reeb graph, the new edge being connected to a saddle vertex that is a boundary vertex.

Other aspects and features of the present invention will become apparent to those ordinarily skilled in the art upon review of the following description of specific embodiments of the invention in conjunction with the accompanying figures.

### BRIEF DESCRIPTION OF THE SEVERAL VIEWS OF THE DRAWING(S)

Embodiments of the present invention will now be described, by way of example only, with reference to the attached Figures, wherein:

FIG. 1: Disclosed method system diagram

FIG. 2: Host device: Photo or video camera;

FIG. 3: Host device: Automated vehicle;

FIG. 4: Host device: Surveillance camera;

FIG. 5: Prior art: Reeb-shape methods;

FIG. 6: Prior art: Embedded implementation architecture for Reeb-shape methods;

FIG. 7: Reeb graph imbedding using disclosed method;

FIG. 8: Embedded implementation architecture including disclosed method;

FIG. 9: Prior art: Generating shape data from Reeb graph regions;

FIG. 10: Disclosed method results in different collection of shapes;

FIG. 11: Reeb graph annotated with seeds for contour following;

FIG. 12: Embedded implementation architecture for Reeb-graph stage;

FIG. 13: Embedded implementation architecture for disclosed method;

FIG. 14: Prior art: Visualization of shape data for image of a cat;

FIG. 15: Visualization of shape data for image of a cat, exhibiting effect of disclosed method;

FIG. 16: Prior art: Visualization of shape data for image of a person;

FIG. 17: Visualization of shape data for image of a person, exhibiting effect of a first form of disclosed method;

FIG. 18: Visualization of shape data for image of a person, exhibiting effect of a second form of disclosed method;

FIG. 19: Prior art: Visualization of shape data for image of a road scene; and

FIG. 20: Visualization of shape data for image of a road scene, exhibiting effect of disclosed method.

### DETAILED DESCRIPTION OF THE INVENTION

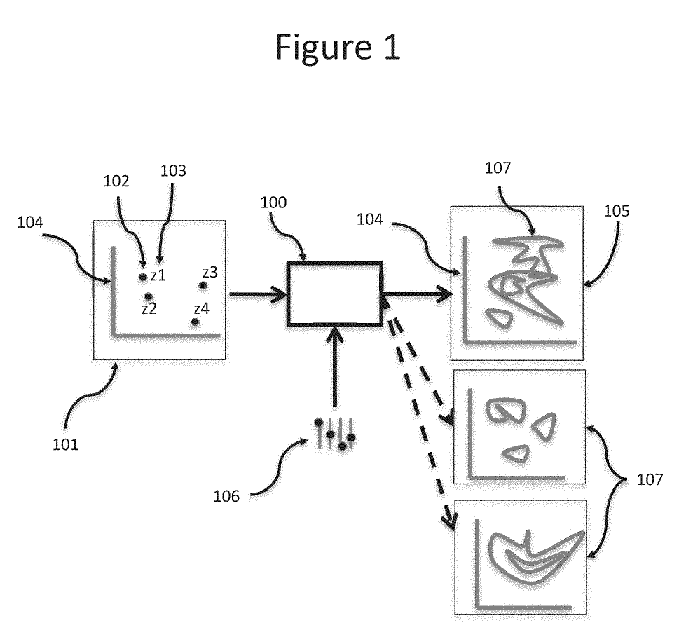

A disclosed method has embodiments that extend and improve existing systems for topological data analysis, as shown in FIG. 1, wherein an existing system (100), embodied within a host device, transforms a point dataset (101) to data describing a collection of shapes (105), with the disclosed method providing choice to the host device and its user from among a multitude of collections of shapes (107). The disclosed method provides a new source of control for optimization of devices that utilize shape data, including embodiments within mobile, embedded and real time applications and products.

The input dataset (101) comprises a representation of a multitude of datapoints, each located, e.g. (102), within a boundary, connected spatial domain (104), e.g. a two- or three-dimensional region, where each datapoint associates its location (102) with a scalar or vector value, e.g. (103).

The system (100) outputs shape data (105) representing a collection of shapes, where each shape, e.g. (107), is a connected region of the spatial domain (104). Shape data may describe individual shapes, and may also describe relations between shapes, such as one shape containing another.

The disclosed method extends and improves existing systems (100) by providing the host device and its user a multitude of choices (106) from among a multitude of alternative collections of shape data (107); specifically, the disclosed method effects such choice by means of a multitude of “topology imbeddings”, described below.

Embodiments of the disclosed method may include host device and user control within applications such as:

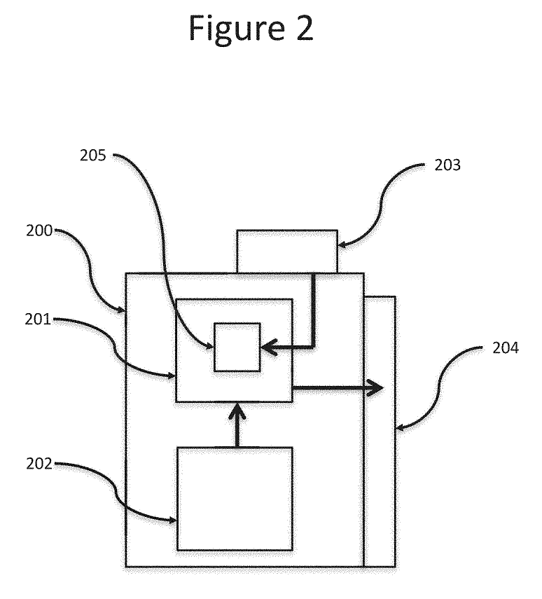

Photo camera (FIG. 2): An image sensor captures a pixel image (202). User manually selects her preferred shapes while using camera (200), with shapes generated by on-camera chip (201) from the captured pixel image (202), by turning rotary many-position switch (203) on camera's exterior while viewing the resulting shapes displayed on the camera's screen (204). Each switch position (203) selects a different topology imbedding for the embodiment of the disclosed method (205) within the chip (201), resulting in variation of the shapes seen onscreen (204) by the user, who makes her choice from the shapes' visual appearance, based on aesthetic or other considerations.

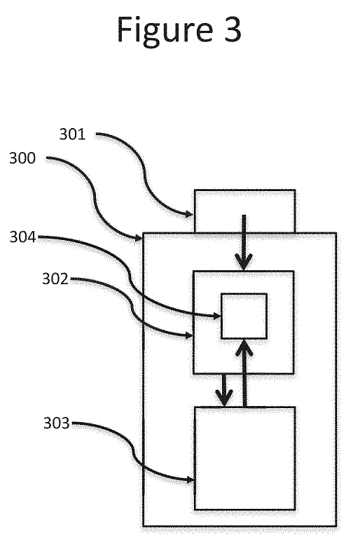

Automated vehicle (FIG. 3): Lidar range data (301) of the environment around the vehicle (300) is processed into shape data in real time by dedicated electronics (302). Shape data is used within the vehicle control system (303) to improve vehicle operational safety by identifying the presence of obstacles on the road ahead of the car. When the vehicle control system (303) suspects the presence of an obstacle, it utilizes the disclosed method (304) to generate a multitude of alternative shape data, searching for a shape dataset that either confirms or refutes the presence of an obstacle. The vehicle control system (303) will take appropriate action and inform the driver using the vehicle user interface.

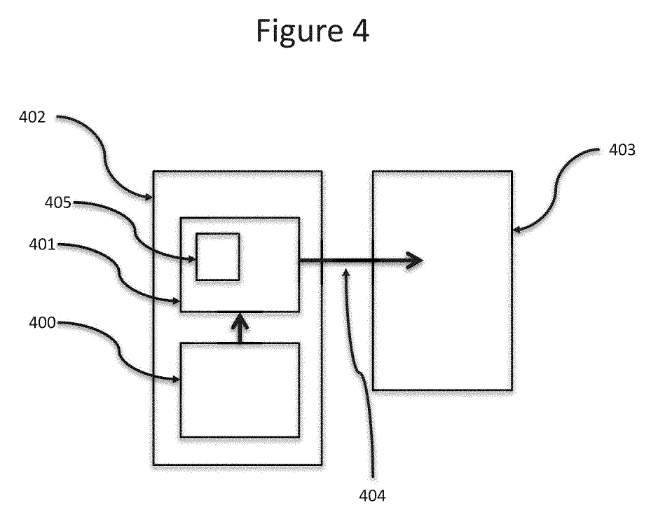

Surveillance camera (FIG. 4): Surveillance camera (402) captures and image. Human face and body shape data are generated by chip (401) from image (400) in surveillance camera (402) and transmitted to a remote surveillance analysis system (403) via network (404). Remote system (403) applies person-of-interest recognition methods to the shape data received over network (404). Chip (401) utilizes the disclosed method (405) to choose one from among a multitude of alternative topology imbeddings for the shape data generated from the camera image (400), with the optimal choice of topology imbedding determined by the chip (401) individually for each image transmitted to the remote system (403). For each image (400) from camera, chip (401) determines which shape data to transmit by repeatedly using the disclosed method (405) to generate variations in the shape data, from which the chip (401) selects the shape data optimizing the value of an objective function characterizing the remote analysis system's (403) shape data requirements for effective identification of persons of interest.

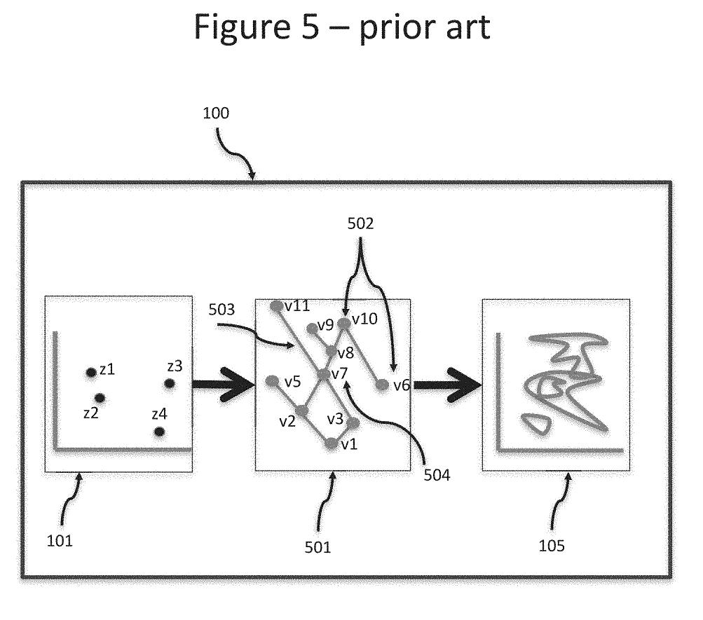

FIG. 5 summarizes prior art for generating shape data by what is herein called a “Reeb-shape method”: System (100) receives input comprising a point dataset (101), transforming the input (101) to shape data (105) in two stages: A “Reeb graph stage” that transforms the input dataset to a representation of a graph structure known to persons skilled in the art as a Reeb graph (501); and a subsequent “shape-generation stage” that generates shape data (105) from the representation of the Reeb graph (501). Some embodiments may have only these two stages; other embodiments may include a multitude of data transforms before, after or between the Reeb-graph and shape-generation stages.

Embodiments of the disclosed method are an extension to, and may be an improvement to, embodiments of the prior art just described, and may add value to devices that physically embed this prior art.

Within some embodiments of Reeb-shape methods, the input dataset (101) might be a one-, two-, or three-dimensional array of numerical measurements provided by a sensor that is physically located on the host device. For example, each datapoint might be represented by a vector [x, y, z, v] comprised of three spatial coordinates and a scalar sensor value, with each number coded within the host device's digital circuits as IEEE floating point numbers.

Herein the word “shape” refers to a closed, connected subset of the spatial domain (104). Embodiments of shape utilize specific data formats compatible with the host device. Shape data representations may vary by purpose, for example: a two-dimensional shape to be displayed on a screen might be represented as a scalable vector graphics (SVG) polygon; or a shape that will be further processed by a machine learning system might be represented as a vector of geometric and topological attributes, such as area, perimeter, and number of holes.

As shown in FIG. 5, the Reeb graph (501) is comprised of a multitude of vertices, e.g. (502), and edges, e.g. (503), with a scalar value, e.g. (504), labeling each vertex.

The Reeb graph is well known to persons skilled in the art. Herein the term “Reeb graph” is used in the broadest sense, denoting any graph structure that expresses the connectivity of level sets, sublevel sets, or superlevel sets of a scalar field defined on a spatial domain having boundaries. Each vertex of a Reeb graph is classified as one of maximum, minimum, or saddle. Each edge of a Reeb graph is like the open interval of the number line lying between the scalar value labels of the edge's two vertices; in this way every edge point is considered to be labeled with a scalar value.

Embodiments of the disclosed method provide the host device or user a multitude of choices from among a multitude of topology imbeddings for the Reeb graph, and may thereby effect a choice from among a multitude of collections of shape data.

In some embodiments, the host device for a Reeb-shape method may be a mobile device, e.g. a smartphone or camera; such applications require the physical embodiment of the Reeb-shape method to be embedded within the device, and therefore to be small and low power. In some embodiments, the host device for a Reeb-shape method may require fast or real time throughput. These types of embodiment imply the need to implement Reeb-shape methods by parallel processing on digital microelectronics.

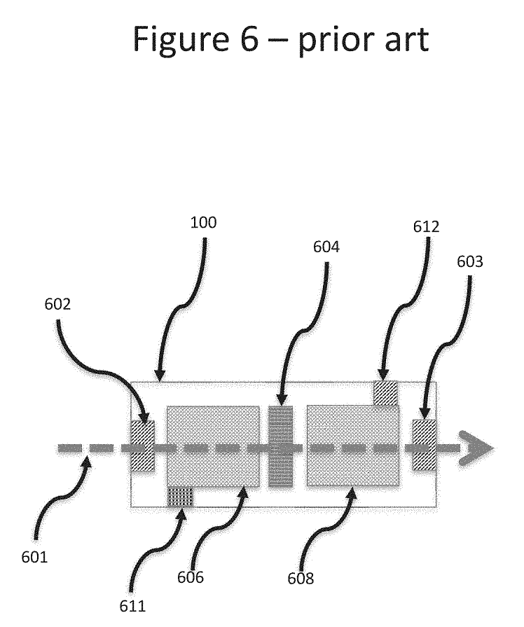

As shown in FIG. 6, a system (100) embodying a Reeb-shape method may be implemented as an asynchronous linear pipeline, having directional flow (601).

FIG. 6 is a high-level reference model for embedded microelectronic implementations of Reeb-shape methods in a system on a chip (SoC), a field programmable gate array (FPGA), an integrated circuit, or a circuit board.

FIG. 6 shows two circuit regions (606, 608) corresponding, respectively, to the Reeb-graph stage and shape-generation stages of Reeb-shape methods. FIG. 6 shows interfaces (602, 603, 611, 612) to off board resources, and shows a dual-port memory block (604) that moves data along the pipeline, providing output from the preceding circuit (606) as input to the following circuit (608). The dual-port memory block (604) and off board interfaces (602, 603, 611, 612) are simplified in FIG. 6 by suppressing detail regarding control logic, double-buffering, handshaking protocols, and power. Off board interfaces are shown separately for logical clarity of purpose, whereas implementations may aggregate these interfaces over a bus.

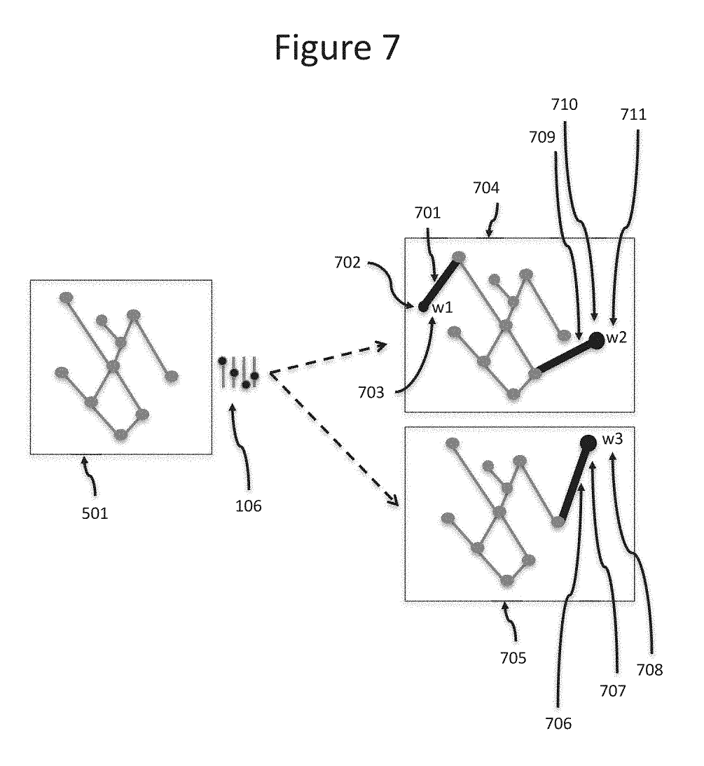

As shown in FIG. 7, the disclosed method extends embodiments of Reeb-shape methods by providing host device and user control (106) of choice among a multitude of topology imbeddings for the Reeb graph (501), where each imbedding comprises augmentation of the Reeb graph by a multitude of new edges (701, 706, 709) and new vertices (702, 707, 710) with each new vertex labeled by a scalar value (703, 708, 711). Each new edge must have a new vertex at least at one end. The scalar value labeling each new vertex must be unequal to any scalar value labeling another vertex to which the new vertex is connected by an edge. Thereby, each choice (106) grows the Reeb graph (501) into a larger “Reeb-like” graph (704, 705), i.e. a graph that might be a Reeb graph for an extension of the dataset to a larger spatial domain.

The disclosed method further entails that when the host device or user chooses a Reeb graph imbedding (106, FIG. 7), then the embodiment of the shape-generating stage proceeds to generate shapes, using the imbedded Reeb graph, e.g. one of (704, 705), serving as a substitute for the original Reeb graph (501). The principle of operation is that the changes to the Reeb graph may cause the shape-generation stage to generate different shape data than it otherwise would have.

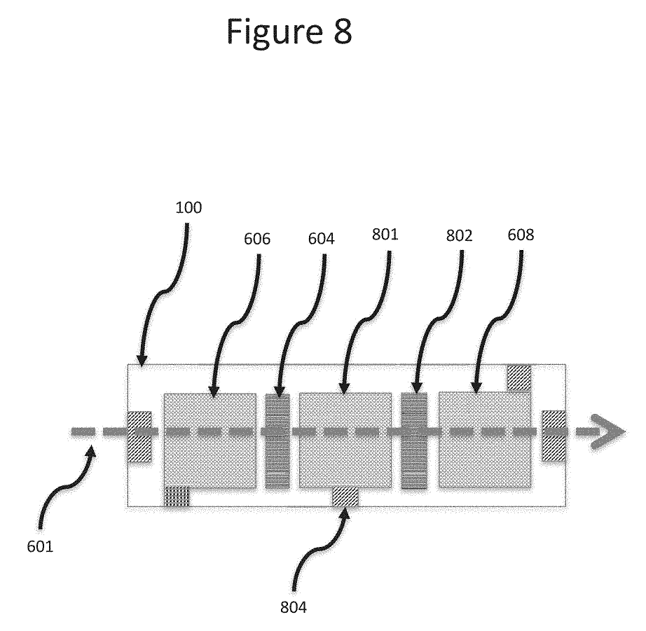

As shown in FIG. 8, some embodiments of the disclosed method may be implemented by expanding the embedded implementation architecture of FIG. 6 to a three-stage pipeline. The pipeline is extended by one additional circuit, augmented Reeb graph stage (801) that implements the disclosed method by augmenting the data representation of the Reeb graph, stored in dual-port memory (604), according to the host device and user choice of Reeb graph imbedding; this choice is represented by data in off board interface (804). Off board interface (804) may receive inputs from a variety of manual and automatic controls including dials, user interfaces, expert systems, predefined parameters, and dynamically determined parameters. Additionally, a feedback control system may be realized using the outputs of the pipeline being input to a control system that generates inputs for the off board interface (804) The additional circuit (801) communicates the imbedded Reeb graph data to the circuit embodying the shape-generating stage (607) via an additional dual-port memory block (802).

Discussion now proceeds to description of benefits to embodiments of the disclosed method.

Embodiments of Reeb-shape methods have been used in prior art for offline computational analysis of stored datasets, wherein it is possible to apply pre-analysis conditioning of the datasets in order to improve the quality of analysis outcomes. Such conditioning might include normalization of the data, elimination of outliers, and other techniques to maximize the data's conformance to the analysis method's best use cases. However, when Reeb-shape methods are applied to sensor data in real-time, mobile or embedded devices, then data conditioning is not always possible. Embodiments of the disclosed method may compensate for variability of raw data by providing a new method of influencing the shape data output, such that a host device and its user can utilize embodiments of the disclosed method to optimize the host device's value and usefulness.

Embodiments of Reeb-shape methods may utilize various forms of filtering within a collection of shape data, such as selection of shapes by depth in a hierarchy, or selection of shapes based on attributes such as area and perimeter. The disclosed method is distinct from, and complementary to, filtering methods, because the disclosed method affects the source from which shapes are generated, i.e. the Reeb graph, whereas filters are applied after shapes already have been generated.

The disclosed method exploits a multitude of alternative Reeb graph imbeddings in order to generate a multitude of alternative collections of shape data. Several classes of Reeb graph imbedding may be used in embodiments of the disclosed method.

As was shown in FIG. 7, a Reeb graph imbedding may comprise augmentation of the Reeb graph by attachment of a multitude of new edges and vertices, where each new vertex is labeled with a scalar value.

As is well known to persons skilled in the art, the Reeb graph of a point dataset is generated by means of a continuous interpolation of the dataset. Some embodiments of Reeb-shape methods may use piecewise linear interpolation, some embodiments may use piecewise polynomial interpolation, some embodiments may use splines, etc. All embodiments share the property that each point of the Reeb graph, including each vertex and each edge point, may be uniquely identified with a connected contour of the interpolated dataset, such that the point's labeled value and the contour's interpolated value are equal. This property provides a classification of Reeb graph vertices: Herein a “boundary vertex” is a vertex identified with a contour that intersects the boundary of the dataset's spatial domain.

Some embodiments of the disclosed method may augment representations of boundary vertices of the Reeb graph; herein these are called “boundary imbeddings”. These embodiments of the disclosed method are a topological generalization of boundary condition methods, such as Dirichlet, Neumann, synthetic, anti-reflective methods, none of which are based on topological structure of the dataset.

Some embodiments of the disclosed method may augment the representation of a first Reeb graph vertex such that this augmentation's new edges and vertices are distinct from the new edges and vertices augmenting any second Reeb graph vertex; herein these are called “free imbeddings”.

Some embodiments of the disclosed method may label representations of the new vertices with scalar values lying outside of the range of values labeling the Reeb graph; herein these are called “projective imbeddings”. For example, for an image dataset might have data values in the range 0-255, and the values assigned by a projective imbedding might be −1 or 256.

Some embodiments of the disclosed method may augment the representation of a Reeb graph vertex only when the vertex has labeled value above or below a threshold value, when the vertex has labeled value lying between or outside two threshold values; herein these are called “threshold imbeddings”.

Some embodiments of the disclosed method may augment representations of Reeb graph vertices with a multitude of new edges and new labeled vertices, as determined by the embodiment of an algorithm; herein these are called “computed imbeddings”.

Some embodiments of the disclosed method may utilize an embodiment of an algorithm to determine which of the above methods, or any other method, should be used to augment the representation of each Reeb graph vertex, i.e. the embodied algorithm is applied individually to each vertex; herein these are called “context sensitive imbeddings”.

In some embodiments, the multitude of alternative Reeb graph imbeddings from which the host device or user may choose may be expressed as rules to be applied to every Reeb graph vertex. In some embodiments, the rules may be restricted to application on boundary vertices. The following list illustrates these categories of augmentation in example Reeb graph imbedding rules:
1. Augment each boundary vertex with one new edge connected to a unique new vertex labeled by value −1. This is a free projective boundary embedding.
2. For each boundary vertex that represents a maximum, augment the vertex with one new edge connected to a unique new vertex labeled by value −1. This is a free conditional projective imbedding.
3. For each boundary vertex that represents a saddle and which has label value less than 150, augment the vertex with one new edge connected to a unique new vertex labeled by value 256. This is a free conditional thresholded projective imbedding.

Discussion proceeds by providing more detail of the principle of operation for embodiments of the disclosed method, with the restriction that all discussed embodiments use only boundary imbeddings expressed as rules.

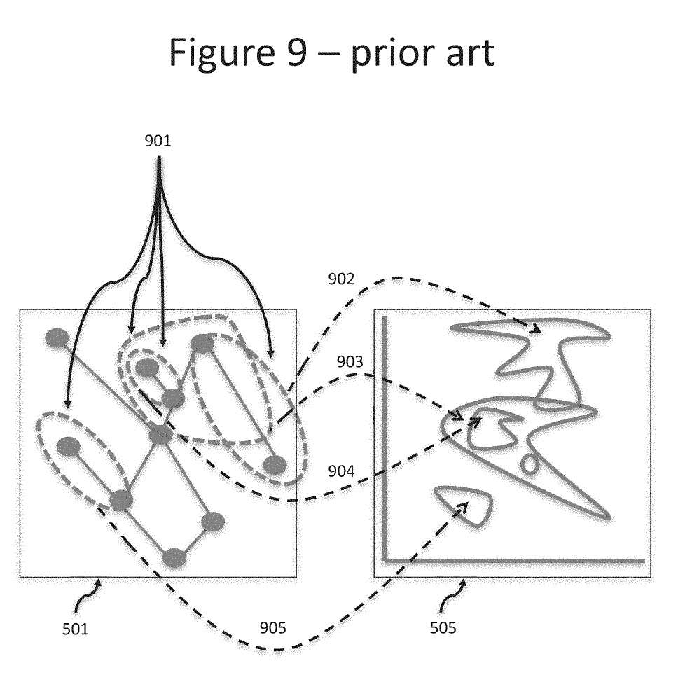

As shown in FIG. 9, some embodiments of Reeb-shape methods may implement the shape-generation stage by utilizing a collection of subsets of the Reeb graph, indicated in FIG. 9 by circling (901) each subset, such that the shape-generating stage generates data representing one or more unique shapes from each subset, with such correspondences between subsets and shapes indicated in FIG. 9 by dashed arrows (902, 903, 904, 905).

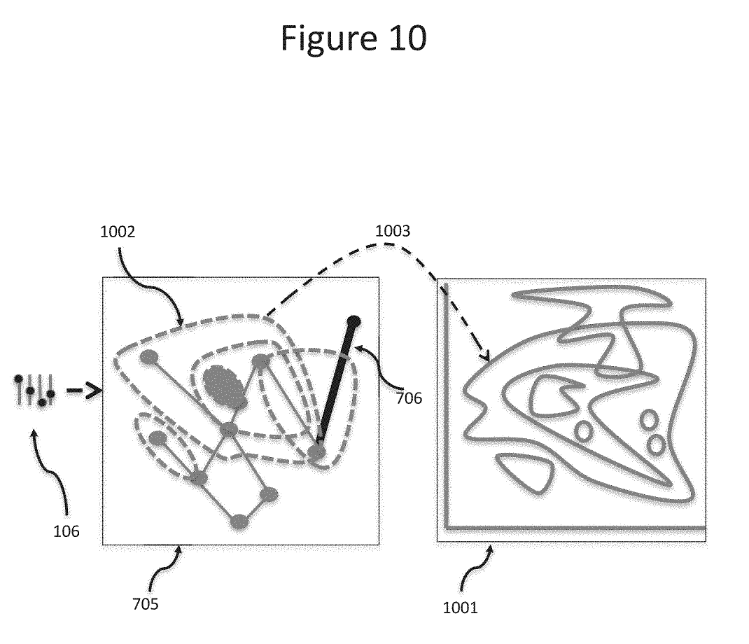

As shown in FIG. 10, when the disclosed method is implemented within embodiments described in the previous paragraph, then host device or user choice (106) results in an imbedded Reeb graph (705) that may be used by the embodiment's shape-generating stage. FIG. 10 shows one subset (1002) that was not present in FIG. 9. Consequently, the shape-generation stage generates data for an additional shape, with the correspondence shown (1003).

Discussion now proceeds to further description of embodiments of Reeb-shape methods incorporating the disclosed method.

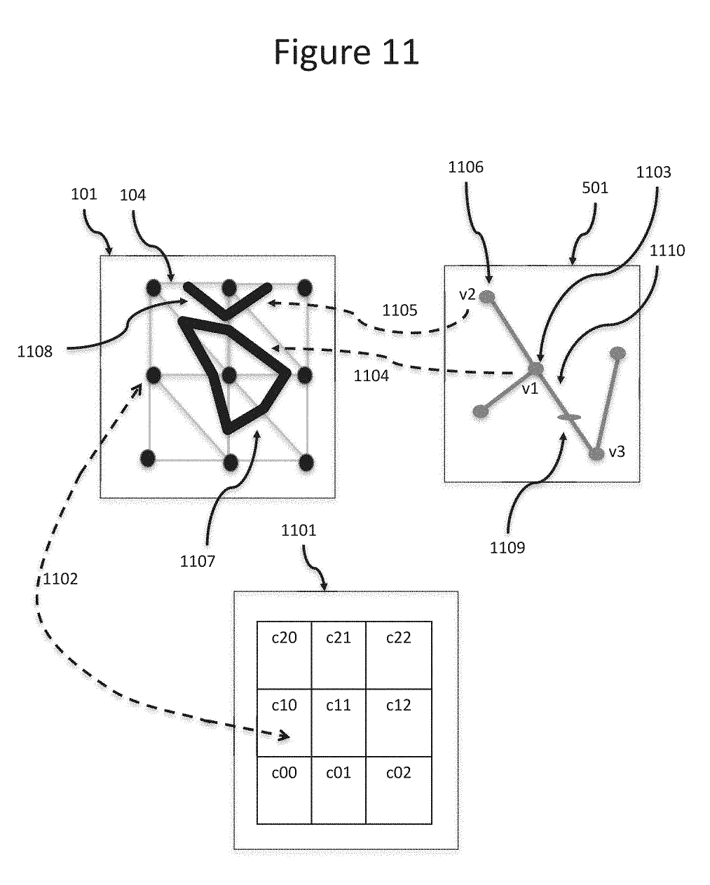

As shown in FIG. 11, in some embodiments, the dataset (101) results from a color, multispectral or grayscale image represented by an N×M rectangular grid of pixels (1101). In such embodiments, the dataset's spatial domain (104) may be an (N−1)×(M−1) rectangular planar region having datapoints in one-to-one correspondence with image pixels, shown by dashed double-arrow (1102), with datapoint at plane coordinates X,Y having scalar value calculated from the value of the image pixel at grid coordinates X,Y, where this scalar value calculation may comprise selection of a single color channel in the image's color space, or in a derived color space such as LAB; alternatively, the scalar value calculation may result from embodiments of decolorization methods. Because the image spatial domain has no holes within its boundaries, the image's Reeb graph (501) has no loops, and is known to persons skilled in the art as a contour tree.

In image analysis embodiments, the input image may be represented in a standard format, e.g. JPEG, TIFF, PNG, GEOTIFF, DICOM, raw camera formats, and others; the output may use these formats to represent shape data as a pixel image, and shape data may also be represented in formats for diverse uses, e.g. scalable vector graphics (SVG), or machine learning vector data.

As shown in FIG. 11, in some embodiments, the dataset's rectangular spatial domain (104) may be conceptually subdivided into triangles, each having datapoints at the corners. In such embodiments, a representation of the Reeb graph (501) may be generated using a first method, referred to herein as “Method A”, in which the representation of the Reeb graph includes representation of annotations providing an association of each point of the Reeb graph, including each vertex and each edge point, with one of the triangles; example annotations are shown in FIG. 11 as dashed arrows (1104, 1105). Method A requires that no two Reeb graph vertices are labeled with equal scalar values; to meet the requirement, embodiments must represent the data values with sufficient precision to allow small perturbations of value.

As shown in FIG. 11, as is known to persons skilled in the art, each point of the Reeb graph, including each vertex and each edge point, may be identified with a unique connected contour of the dataset's piecewise linear interpolation on the triangular subdivision. FIG. 11 shows Reeb graph vertex (1103) identified with contour (1107), and vertex (1106) identified with contour (1108). The scalar value labeling each Reeb graph point is equal to the contour value. Thus, contour (1108) has value v2, and contour (1107) has value v1.

In the case of Method A, each Reeb graph point is annotated by a triangle containing a linear segment of the point's contour; this is why dashed arrows (1104, 1105) indicate both the vertex-triangle annotation and vertex-contour identification. Thus, the triangle annotating each Reeb graph point serves as a seed for a contour following method, herein called “Method B”.

As described in the above list of Reeb graph imbedding types, a boundary imbedding augments boundary vertices, and a boundary vertex's contour intersects the boundary of the dataset's spatial domain. Embodiments of the disclosed method may use Method B to identify Reeb graph boundary vertices: In some embodiments, computer code or a dedicated circuit may determine whether a vertex is a boundary vertex by looking up the vertex's annotation by a triangle, and then using the vertex's labeled value to locate the vertex's contour within the triangle, and then use Method B to follow the contour through the triangular subdivision of the spatial domain, checking whether or not the contour intersects the spatial domain's boundary. In FIG. 11, Reeb graph vertex (1106) is a contour vertex, and vertex (1103) is not a contour vertex.

Discussion now proceeds with details for circuit (606) shown in FIG. 8, the Reeb-graph stage.

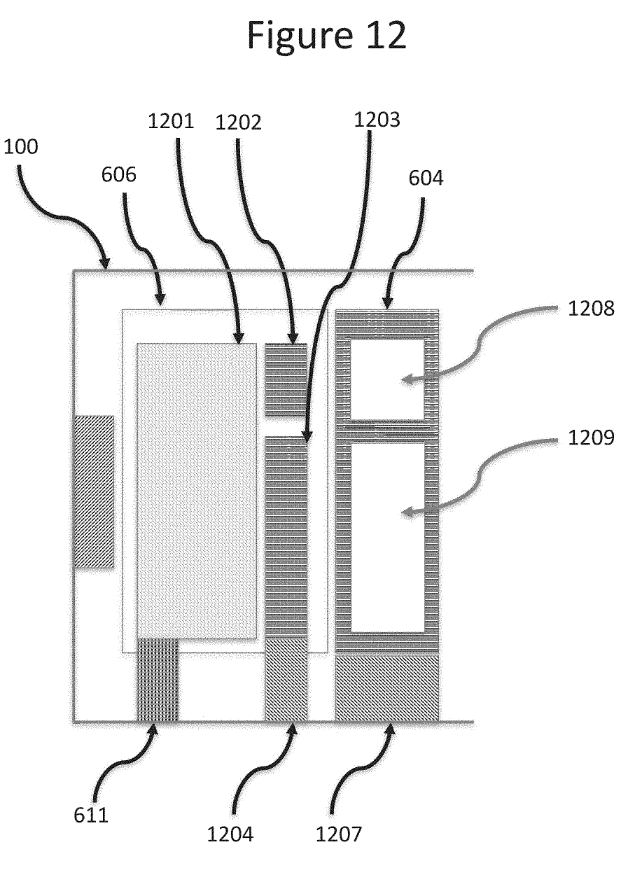

FIG. 12 shows an exemplary layout of the Reeb-graph circuit (606) of FIG. 8 illustrating embodiments utilizing Method A. In such embodiments, the circuit (606) may contain a compute device (1201) having multiple CPU cores proximal to onboard read-only memory (1202) storing computer code for Method A and the CPU operating system. The multiple CPU cores (1201) have shared access to local memory (1203). The embedded implementation architecture of FIG. 12 provides for the possibility that the memory needed by method A exceeds local memory (1202), and thus interface (1204) provides access to extension of local memory (1202) by off board memory. In this embodiment, it is not assumed that three datasets can be stored onboard, i.e. one dataset for each stage; interface (611) provides the CPU cores with shared access to the dataset in off board memory. Nor is it assumed that this stage's output fits within the dual-port memory (604); interface (1207) provides extension of dual-port memory (604) to additional off board memory. The multicore CPU (1201), memory blocks (1202, 1203), and off board interfaces (611, 1204, 1107) are simplified in FIG. 12 by suppressing detail regarding control logic, and cache management.

As is known in the art, computer code for Method A executes on a multicore CPU (1201) under supervision of a symmetric multiprocessing (SMP) operating system. Method A results in two tables (1208, 1209) written to the dual-port memory (604). Table (1209) represents the vertices and edges of the Reeb graph, and table (1208) represents the Reeb graph's annotations by subdivision triangles (1104, 1105 FIG. 11).

In some embodiments, representation of the Reeb graph by table (1209) may be implemented with two arrays T1 and T2, with T1 representing the Reeb graph's vertices, and T2 representing the Reeb graph's edges. In such embodiments, array T1 might be a one-dimensional array of length L, with one entry for each vertex, storing each vertex's labeled value in a data format such as IEEE float, or as two integers A, B representing rational number A/B. In some embodiments, array T2 might be a sparse two-dimensional L×L binary array, where the presence or absence of a Reeb graph edge connecting two vertices, each represented in array T1 at, respectively, indices k1 and k2, is indicated by the bit stored in array two-dimensional T2 at index (k1, k2). Alternatively, some embodiments may implement array T2 as a hash table, e.g. with a concatenation of the representations of indices k1 and k2 as key.

In some embodiments, table (1208) may represent Method A's triangle annotation of Reeb graph points (1104, 1105, FIG. 11) by representing each triangle with numerical representations of the X, Y coordinates of the triangle's upper left corner, with an additional bit to disambiguate between the two triangles sharing this upper left corner point; this scheme can be generalized for three-dimensional and other spatial domains different from the two-dimensional domain illustrated in FIG. 11.

In such embodiments, table (1208) may be implemented with two arrays T3 and T4, with T3 representing triangle annotations for vertices and T4 representing triangle annotations for edge points of the Reeb graph.

Array T3 may be a one-dimensional array of length L, where L is the number Reeb graph vertices, with the array cell of array T3 at index k3 containing the representation of the triangle annotating the vertex at the same index k3 in table T1.

Array T4 may have the same structure as array T2, e.g. sparse two-dimensional array or hash table accessed by the pair k1, k2 of vertex indices for an edge. To retrieve the representation of the annotating triangle of Reeb graph edge point P, e.g. (1109, FIG. 11), lying on Reeb graph edge E, e.g. (1110), the edge E may be represented by the pair of vertex indices k1, k2 from array T1, and point P may be represented as its scalar label value. As known to persons skilled in the art, edge E may be partitioned by an ordered sequence of scalar values such that all edge points in the same partition element are annotated with the same triangle by Method A. In FIG. 11, for edge (1110) these ordered values all lie between scalar values v1 and v3. Thus it suffices to represent the unique association of each partition element with its annotating triangle. In some embodiments, the partition elements for Reeb graph edge E may be represented by entries in a one-dimensional array T5 that stores the partitions for all edges of the Reeb graph, where the index for the first partition element of edge E in T5 has been stored in array T4 at the array cell indexed by the pair k1, k2 of vertex indices for edge E.

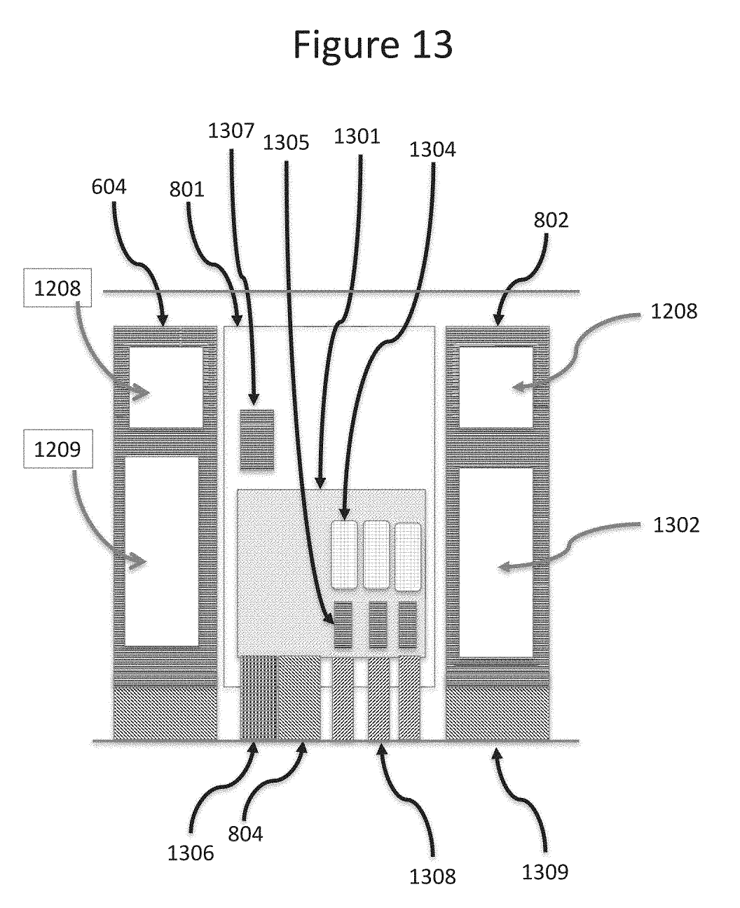

Discussion now proceeds by embellishing circuit (801, FIG. 8) to implement the disclosed method, shown in FIG. 13. The disclosed method provides the host device and user a multitude of choices from among a multitude of Reeb graph imbeddings, using the Reeb graph data, represented in table (1209) stored in dual-port memory (604); circuit (801, FIG. 8) adds more data to this table, resulting in table (1302), stored in dual-port memory (802), where this additional data represents the new vertices and edges resulting from Reeb graph imbedding.

The chosen Reeb graph imbedding is represented by data in off board interface (804), thereby determining how compute device (1301) expands the Reeb graph's representation in table (1209) to table (1302). In some embodiments, the compute device (1301) may also copy the Reeb graph triangle annotation table (1208) to dual-port memory (802), i.e. if it is needed by the shape generation stage implemented in circuit (608, FIG. 8).

To implement Reeb graph imbedding, compute device (1301) manages a queue containing a multitude work groups that it dynamically assigns to a multiplicity of compute units, e.g. (1304), each having local memory, e.g. (1305). The compute units execute work groups asynchronously in parallel. Each compute unit has access to the augmentation rule via off board interface (804), and has access to triangle annotation table (1208), and has access to the dataset via off board memory interface (1306).

When assigned a work group, each compute unit, e.g. (1304), processes the representations of a multitude of Reeb graph vertices from table (1209); for example, these vertices may be adjacent in their representation in table (1209). The compute unit, processes the work group's collection of vertices using parallel processing elements (not shown).

Each processing element of a compute unit will implement Method B to follow the vertex's contour, thereby determining whether the vertex is a boundary vertex, and if it the vertex is a boundary vertex then the processing element will carry out the Reeb graph augmentation as specified by the rule represented by the data in off board interface (804). The processing element will use the vertex's triangle from triangle annotation table (1208), and the dataset, accessed via off board memory interface (1306). When the processing element's vertex is a boundary vertex, and any conditions or thresholds present in the rule are also satisfied by the vertex and its labeled value, then the processing element adds a new edge and labeled vertex to table (1302) as indicated by the Reeb graph imbedding rule represented by the data in off board interface (804). In some embodiments, the processing element may not carry out the augmentation, instead passing it via local memory, e.g. (1305) to its compute unit or the compute device (1301), so that a batch comprising a multitude of augmentations may be carried out by the compute unit or compute device (1301) in order to more efficiently coordinate parallel write access to table (1302).

In some embodiments, compute device (1301) may be an FPGA or GPU circuit block, whereas in some other embodiments compute device (1301) may comprise a multitude of CPU cores, e.g. an Intel Xeon Phi circuit block, or custom circuits surrounding a multitude of individual CPU blocks; discussion continues by considering CPU-based implementations. In these embodiments, each of the compute device's compute units is a hardware CPU thread executing computer code, including computer code for Method B, that may access the compute unit's local memory, e.g. (1305). FIG. 13 shows each compute unit's local memory with an expansion interface, e.g. (1308), to off board memory used by the CPU hardware thread in case its local memory is insufficient. Off board interface (1309) provides extension of dual-port memory (802) to off board memory, in case it is needed to store tables (1208) and (1302). Read-only memory block (1307) stores the computer code used by the CPU cores.

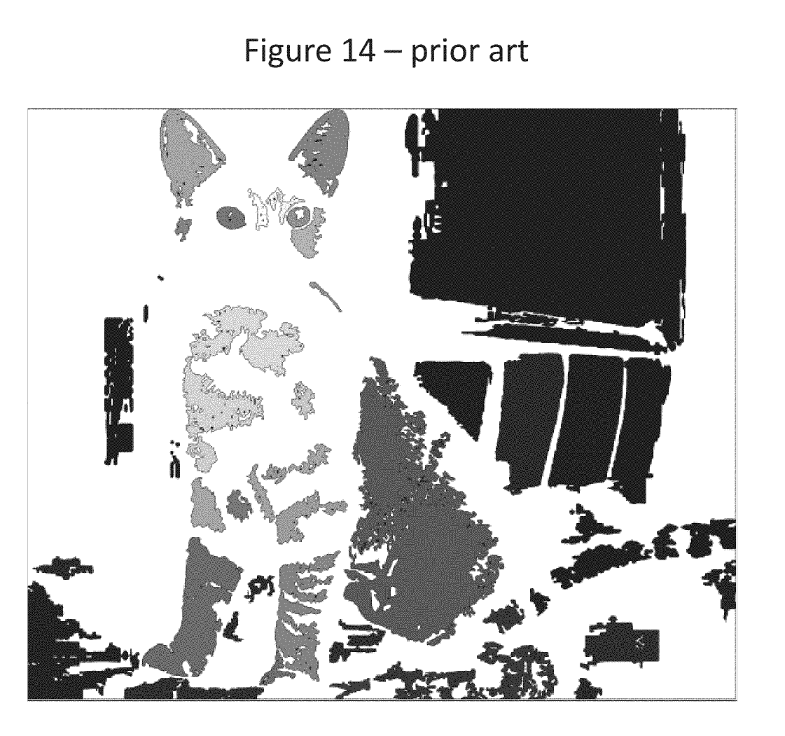

Discussion now proceeds to image and shape examples generated by a simulated embodiment that incorporates the disclosed method into Reeb-shape methods; FIGS. 14-20 were generated by the simulated embodiment as described in the text describing each figure. The simulated embodiment has the three stages of the embedded implementation architecture of FIG. 8. The datasets used in FIGS. 14-20 are color images. The figures comprise pixel renderings of scalable vector graphics (SVG) visualizations of shape data. The shape data generated by the simulated embodiment can be embodied in common formats, for example: a matrix of integers, a vector of IEEE floats, or an SVG (XML) text file.

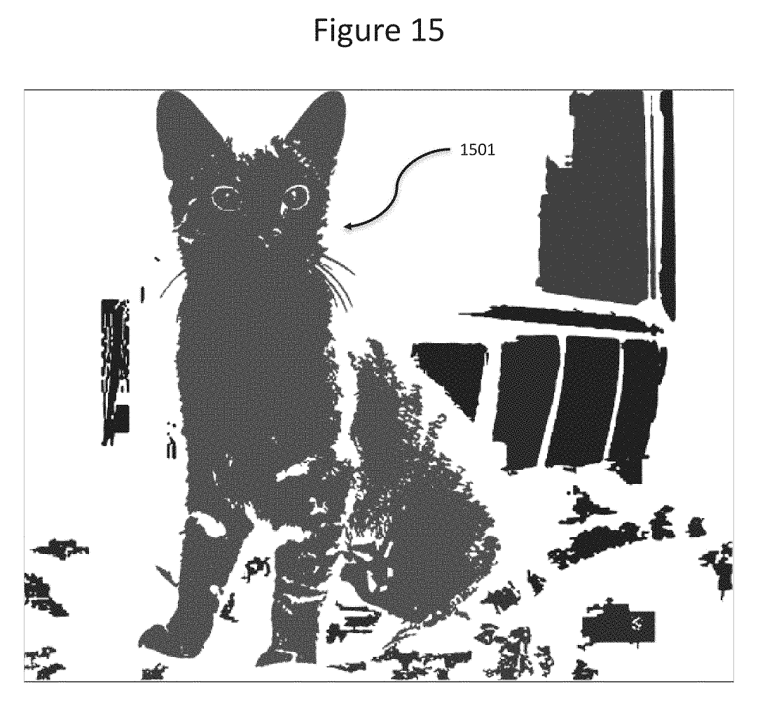

FIG. 14 comprises visualization of shape data generated by the simulated embodiment upon receiving input in the form of a JPEG file containing data representing a 431×359-pixel color image of a cat. This file may serve as training data for machine learning. The disclosed method may benefit embodiments of machine learning image recognition methods. Some embodiments may seek shape data representing salient visual cues for recognition of image content. The disclosed method may improve the saliency of shape data. Without use of the disclosed method, the simulated embodiment generates data for the 61 shapes of FIG. 14. FIG. 15 shows a result of the disclosed method's Reeb graph imbedding, using a conditional rule that augmented 131 of the Reeb graph's 32,006 vertices, selected by applying the rule's predicate to the Reeb graph's 3,552 boundary vertices. The single large shape (1501), among the 41 shapes generated from the imbedded Reeb graph, may be highly salient within embodiments of recognition methods.

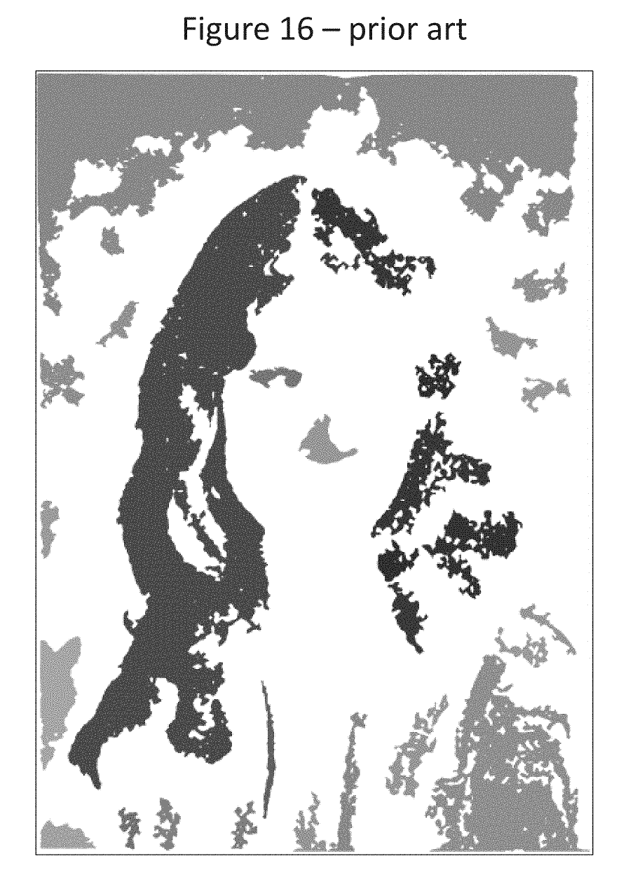

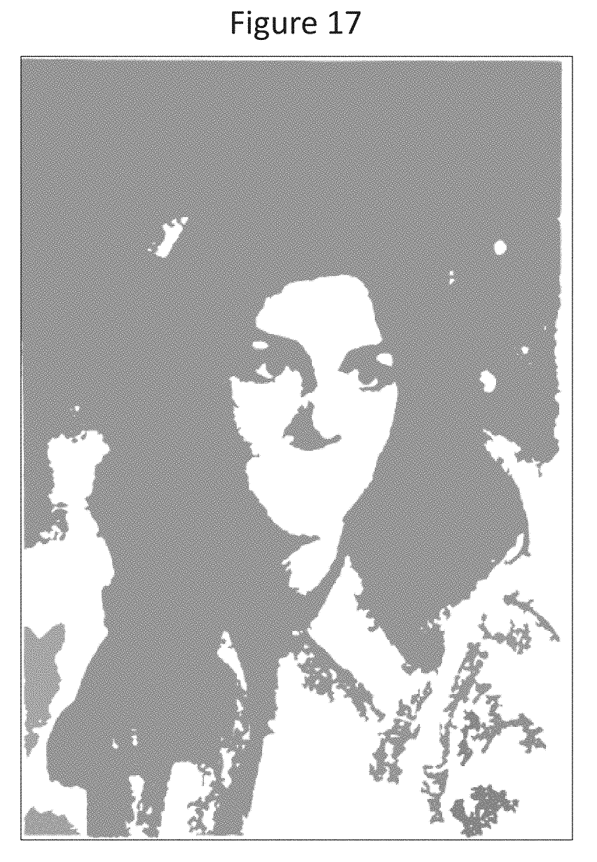

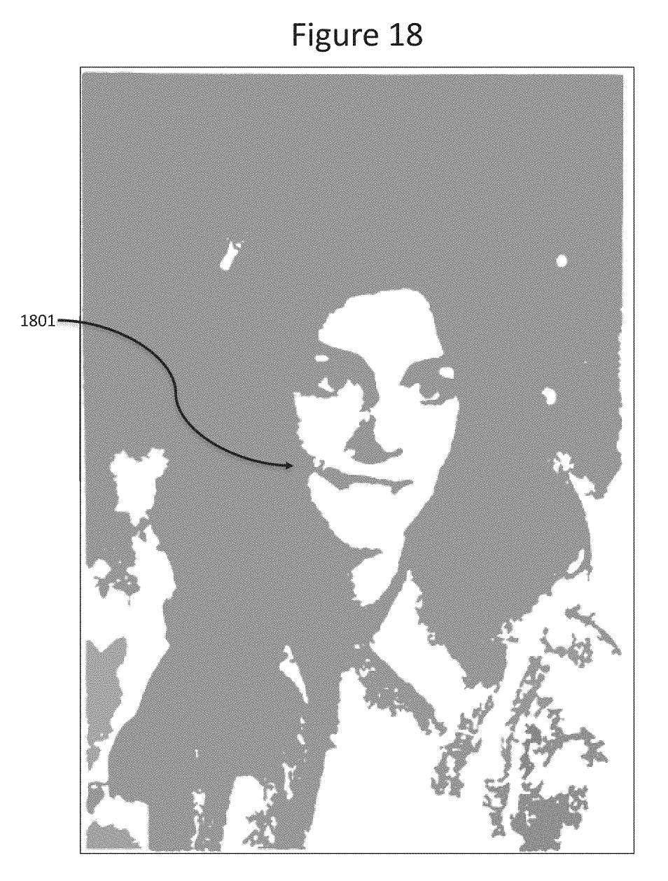

FIG. 16 comprises visualization of shape data generated by the simulated embodiment upon receiving input in the form of a TIFF file containing data representing a 256×256-pixel color image of a person's head and shoulders. A similar image might be captured by a surveillance camera that physically embeds an embodiment of a Reeb-shape method. As was described by FIG. 4, in some embodiments, the disclosed method may be used to optimize the value of transmitted shape data. In some embodiments, that purpose may be to ascertain that a person's face is captured in the camera view, using embodiments of pattern recognition methods that locate facial features, including two eyes, a nose and mouth. Whereas the 34 shapes in FIG. 16 were generated without use of the disclosed method, an improved surveillance camera might also contain an embodiment of the disclosed method, utilizing a conditional rule for Reeb graph imbedding to generate the 14 shapes of FIG. 17; this rule augmented 141 of the Reeb graph's 35,199 vertices, selected by applying the rule's predicate to the Reeb graph's 3,877 boundary vertices. As shown in FIG. 18, shape data representing the surveilled person's mouth (1801) is generated when the imbedding rule includes a threshold restricting augmentation to only the 29 boundary vertices having Reeb graph labels with value in the in the lower half of the range 0-255.

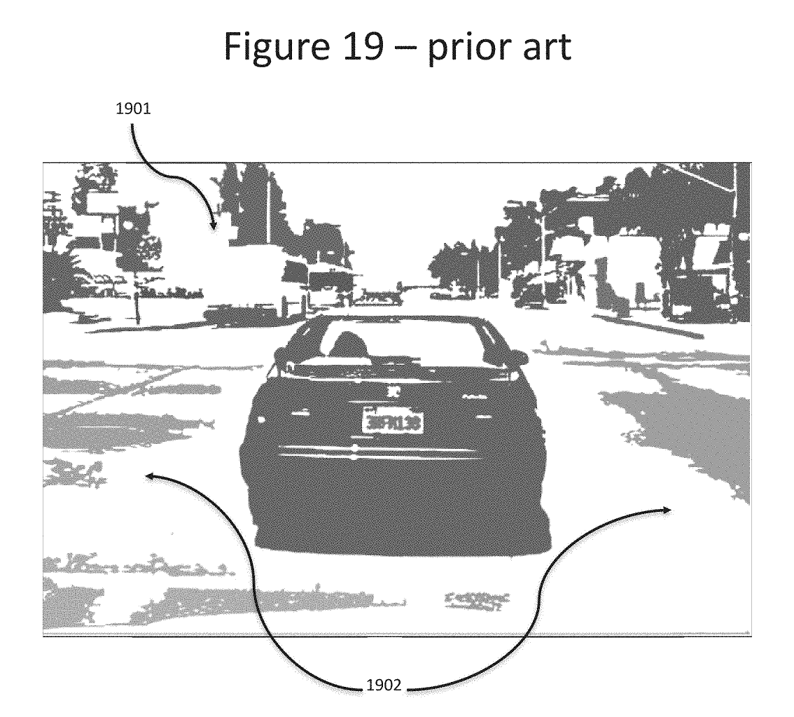

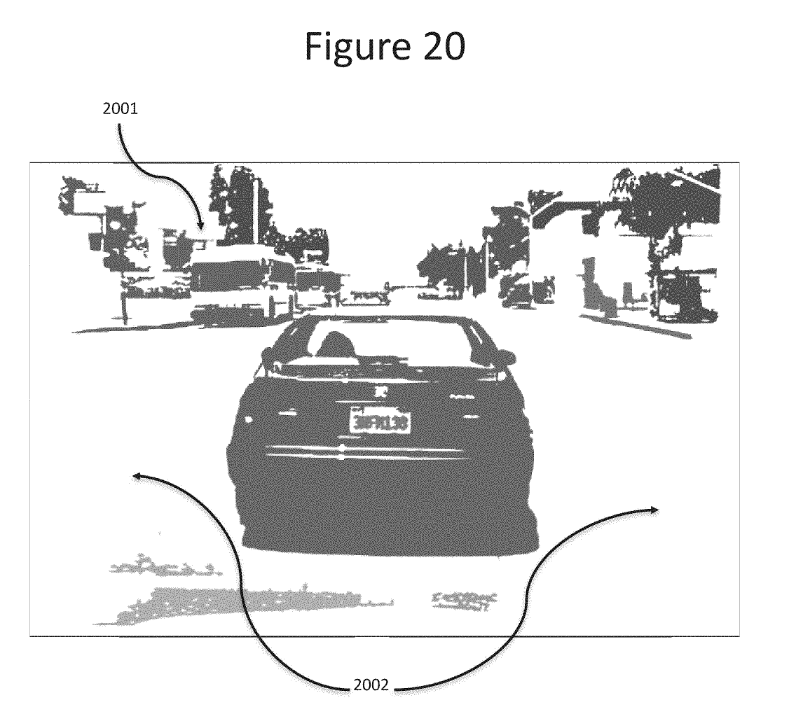

FIG. 19 comprises 26 shapes generated by the simulated embodiment upon receiving input in the form of a JPEG file containing data representing a 360×240-pixel image of a street scene taken from the front of a moving car. As was described by FIG. 3, vehicle control systems may utilize shape data through onboard embodiments of a Reeb-shape method; in some embodiments, as shown by the 17 shapes of FIG. 20, the disclosed method may increase control system performance by means of Reeb graph imbeddings that improve shape data completeness, comparing (2001) and (1901, FIG. 19), and reduce clutter, comparing (2002) and (1902, FIG. 19). The shape data visualized in FIG. 20 resulted from application of a conditional projective Reeb graph imbedding rule that augmented 174 of the 3028 boundary vertices, from among the total of 23,207 Reeb graph vertices.

Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

What is claimed is:

1. A method of transforming image data, the method comprising:
receiving, by a Reeb graph stage, from intermediate storage coupled to a sensor, spatial data;
transforming, by the Reeb graph stage, the spatial data to produce a Reeb graph, the Reeb graph representing the spatial data;
receiving a set of control inputs through an off board interface;
augmenting, by an augmented Reeb graph stage, the Reeb graph to produce an augmented Reeb graph, the augmented Reeb graph comprising a plurality of new edges, each of the plurality of new edges comprising a first vertex labeled with a scalar value, the scalar value being unequal to any other scalar values associated with a second vertex at the opposing end of the new edge, the set of control inputs determining the plurality of new edges;
transforming, by a shape-generation stage, the augmented Reeb graph to produce shape data, the shape data comprising a plurality of shapes; and
outputting, by the shape-generation stage, the shape data.

2. The method of claim 1 further comprising:
receiving a second set of control inputs through the off board interface;
augmenting, by the augmented Reeb graph stage, the Reeb graph to produce a second augmented Reeb graph, the second augmented Reeb comprising a second plurality of new edges, each of the second plurality of new edges comprising a third vertex labeled with a second scalar value, the second scalar value being unequal to any other scalar values associated with a fourth vertex at the opposing end of the new edge, the second set of control inputs determining the second plurality of new edges;
transforming, by the shape-generation stage, the second augmented Reeb graph to product a second shape data, the second shape data comprising a second plurality of shapes;
outputting, by the shape-generation stage, the second shape data; and
selecting one of the shape data or the second shape data.

3. The method of claim 1 wherein the spatial data comprises a plurality of spatial coordinates and a scalar value.

4. The method of claim 2 further comprising displaying one of the shape data or the second shape data on a display.

5. The method of claim 2 wherein the selecting is based a first depth of a first hierarchy of the plurality of shapes and a second depth of a second hierarchy of the second plurality of shapes.

6. The method of claim 2 wherein the selecting is based a first area of the plurality of shapes and a second area of the second plurality of shapes.

7. The method of claim 2 wherein the selecting is based a first perimeter of the plurality of shapes and a second perimeter of the second plurality of shapes.

8. The method of claim 1 wherein the first vertex is a boundary vertex.

9. The method of claim 1 wherein the scalar value lies outside the range of the any other scalar values.

10. The method of claim 1 wherein the scalar value is less than the minimum value of a plurality of scalar values used in the Reeb graph, the new edge being connected to a maximum vertex that is a boundary vertex.

11. The method of claim 1 wherein the scalar value is greater than the maximum value of a plurality of scalar values used in the Reeb graph, the new edge being connected to a saddle vertex that is a boundary vertex.

12. The method of claim 2 further comprising providing one of the shape data or the second shape data to another process.
